(19) United States
(12) Patent Application Publication
(10) Pub. No.: US 2009/0024513 A1
(43) Pub. Date: Jan. 22, 2009

(54) Methods For Intellectual Property Transactions

(75) Inventors: Kevin Arst, San Francisco, CA (US); Michael Milani, Elmhurst, IL (US)

Correspondence Address: STERNE, KESSLER, GOLDSTEIN & FOX P.L.L.C., 1100 NEW YORK AVENUE, N.W., WASHINGTON, DC, 20005, US

(73) Assignee: Ocean Tomo, LLC, Chicago, IL (US)

(21) Appl. No.: 12/174,350

(22) Filed: Jul. 16, 2008

Related U.S. Application Data
(60) Provisional application No. 60/950,461, filed on Jul. 18, 2007.

(51) Int. Cl. G06Q 40/00

(52) U.S. Cl. 705/37

(57) ABSTRACT

A method for transacting intellectual property includes the steps of licensing an IP right corresponding to an IP asset to a licensee according to an agreement; receiving a payment from the licensee for the IP right according to terms of the agreement; and if a call or put option provision in the agreement is exercised, then receiving payment of the strike price and transferring ownership of the IP asset to the licensee. The call option provision provides the licensee the right to purchase the IP asset at a predetermined strike price within a specified time period. The put option provision provides the IP owner a right to sell the IP asset at a predetermined strike price.

### CROSS REFERENCE TO RELATED APPLICATION

This application claims the benefit of U.S. Provisional Application No. 60/950,461, filed Jul. 18, 2007, the entire disclosure of which is incorporated in its entirety herein by reference thereto.

### BACKGROUND OF THE INVENTION

1. Field of the Invention

The invention relates to methods for transacting intellectual property.

2. Background Art

In the financial marketplace, derivatives are commonly used to manage the risk and uncertainty associated with owning underlying assets. As their name implies, derivatives are financial instruments that derive their value and payoffs from underlying assets. Two common forms of derivatives are call options and put options. The owner of a call option has the right, but not the obligation, to buy the underlying asset at a predetermined strike price within a specified time period. For example, a 1-year call option on one share of Acme stock with a strike price of $100 would provide its owner with the right, but not the obligation, to buy the Acme stock share for $100 for a period of 1-year. If over the course of the ensuing year, the price of Acme stock appreciated to $120 per share, the call option may be “exercised” by its owner, netting $20 of profit (i.e., the $120 stock share would be bought for only $100 under the terms of the call option). Alternatively, if over the course of the ensuing year, the price of Acme stock fell to $80 per share, the call option would not be exercised by an economically rational owner; rather, the call option would expire worthless.

Conversely, the owner of a put option has the right, but not the obligation, to sell the underlying asset at a predetermined strike price within a specified time period. For example, a 1-year put option on one share of Acme stock with a strike price of $100 would provide its owner with the right, but not the obligation, to sell the Acme stock share for $100 for a period of 1-year. If over the course of the ensuing year, the price of Acme stock fell to $80 per share, the put option may be exercised by its owner, netting $20 of profit (i.e., the $80 stock share would be sold for $100 under the terms of the put option). Alternatively, if over the course of the ensuing year, the price of Acme stock appreciated to $120 per share, the put option would not be exercised by its economically rational owner; rather, the put option would expire worthless.

Put and call options can be used as a means to manage the risk and uncertainty associated with owning stock. For example, the owner could “insure” his investment in Acme stock by buying a put option that would allow for the sale of the stock at a “locked-in” price in the event of a market downturn. The same owner could buy a call option to preserve his ability to purchase Acme stock in the future at the “locked-in” price in the event of a market upswing.

Typical intellectual property (IP) licensing royalty structures—comprised of some combination of lump-sum and/or running-royalties—confront would-be licensors and licensees with uncertainty and tradeoffs. For example, under a lump-sum structure for a licensed patented technology, the licensor would receive upfront royalty compensation but would not participate in future success of the licensed technology. In this scenario, the licensee would bear the risk and rewards associated with the future commercialization of the technology, and the licensor's payoff would remain fixed irrespective of the future commercial success or failure of the licensed technology. Conversely, under a running-royalty structure, the licensor would receive on-going royalty compensation in the event of a successful technology commercialization, but would also bear the risk of payment default in the event of an unsuccessful commercialization. Traditionally, licensors and licensees have attempted to manage the lump-sum/running royalty tradeoff by negotiating additional payment provisions, such as guaranteed maximum or minimum payments, periodic milestone payments, and/or equity based compensation.

Successful IP licensing transactions provide “win-win” outcomes for both the licensor and the licensee—that is, both negotiating parties realize a benefit under the consummated transaction. However, defining mutually-agreeable terms and license payment structures can present challenges for licensors and licensees alike, particularly when the commercial potential for the IP under consideration is unproven or unknown at the time of the negotiation. The dilemma of successfully pricing early-stage IP is further exacerbated when one or both of the negotiating parties is resource constrained or lacks experience in the relevant market. IP transaction structures that anticipate the ever-expanding goals and objectives of the negotiating parties are therefore needed.

### BRIEF SUMMARY OF THE INVENTION

Application of derivative provisions, such as those commonly found in the financial markets, to transactions concerning IP assets may be used to mitigate the risk and uncertainty associated with forecasting the payoffs of a particular IP asset.

Methods of transacting intellectual property are presented. In one embodiment, an IP right corresponding to an IP asset is licensed to a licensee according to an agreement, and payment is received from the licensee for the licensed IP right according to terms of the agreement. A term of the agreement includes an option providing one of (i) a right to the licensee to purchase ownership of the IP asset at a predetermined strike price and (ii) a right to the IP owner to sell ownership of the IP asset at a predetermined strike price. If the option is exercised, payment of the strike price is received from the licensee and ownership of the IP asset is transferred to the licensee.

In another embodiment of a method presented herein, an IP right is obtained by the licensee and payment for the licensed right is made according to terms of the agreement. If the option is exercised, payment of the strike prices is made to the IP owner and ownership of the IP asset is obtained.

In accordance with another embodiment of a method presented herein, an IP asset, a fee for grant of an IP right corresponding to the IP asset, and a strike price for optional transfer of the IP asset are each identified. An agreement is then offered for execution which grants the IP right to a receiving party in exchange for payment of the fee to an IP owner, wherein a term of the license agreement includes at least one of one of (i) a call option providing the receiving party a right to purchase ownership of the IP asset at the strike price and (ii) a put option providing the IP owner a right to sell ownership of the IP asset at the strike price.

In accordance with another embodiment, an IP right corresponding to an IP asset is transferred by an IP owner to a receiving party, according to an agreement. A term of the agreement includes an option providing one of (i) a right to the IP owner to purchase back the IP right at a strike price and (ii) a right to the receiving party to sell the IP right back to the IP owner at a strike price. If the option is exercised, the receiving party receives payment from the IP owner of the strike price and the IP right is transferred to the IP owner.

The methods for transacting IP described herein could be employed by IP transfer professionals as a means for risk transfer and management. For example, a patent license structured with derivative provisions in accordance with the present invention may mitigate the risk and uncertainty associated with licensing technology, whether it be early-stage or late-stage technology. Further, the possibility of ownership transfer of IP within the terms of the agreement would simultaneously encourage licensee investment in the subject technology and discourage licensee design-around efforts. Such derivative provisions to IP agreements may be used to mitigate risk and provide attractive alternatives to those interested in altering the inherent tradeoffs of traditional licensing structures.

### BRIEF DESCRIPTION OF THE FIGURES

FIG. 1 illustrates a method of transacting intellectual property, according to an embodiment of the present invention.

FIG. 2 illustrates a method of transacting intellectual property, according to another embodiment of the present invention.

### DETAILED DESCRIPTION OF THE INVENTION

The invention relates to methods for transacting intellectual property. According to various embodiments of the present invention, intellectual property (“IP”) (also referred to herein as “IP assets”) can include patents, brands, trademarks, domains, copyrights, music and film rights, trade secrets, prototypes, source code, and other intangible assets which may or may not be protected at present and in the future under applicable law.

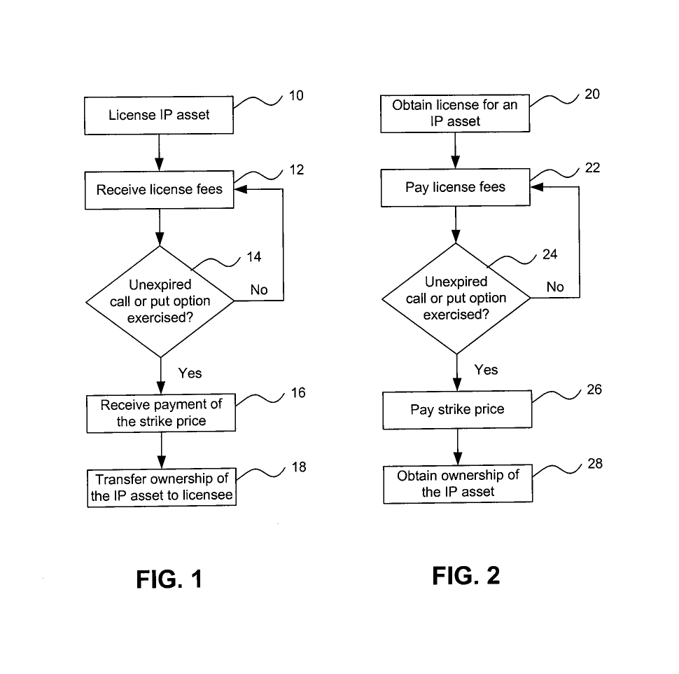

FIGS. 1 and 2 illustrate methods of transacting intellectual property in accordance with the present invention. In particular, FIGS. 1 and 2 illustrate methods that incorporate derivative provisions in intellectual property license agreements. The method steps of FIG. 1 may be from the viewpoint of an IP owner/licensor, and the method steps of FIG. 2 may be from the viewpoint of a licensee. Thus, in the method of FIG. 1, an IP owner/licensor may license an IP asset, particularly, specific IP right(s) corresponding to the IP asset, to a licensee according to a license agreement (step 10) and receive payment(s) for the IP right(s) (step 12). Correspondingly, in the method of FIG. 2, the licensee obtains the license from the IP owner/licensor (step 20) and makes the payment(s) to the licensor according to terms of the license agreement (step 22). The license agreement may include a variety of payment terms, such as an initial up-front payment upon licensing of the IP, on-going royalties during the term of the license, annual maximum or minimum payments, periodic milestone payments, etc., as apparent to one of ordinary skill in the art. The payment or fee for grant of the IP right may include any form of consideration, including, but not limited to money. Thus, the payment may include non-money consideration in combination with or as an alternative to payments of money. In one embodiment, the payment to the IP owner/licensor is a license right in an IP asset owned by the licensee.

The license agreement includes a call option for the licensee to purchase the IP asset at a specified price, or strike price, and/or a put option for the IP owner/licensor to force a sale of the IP asset to the licensee at a same or different strike price. Thus, a call option would provide the licensee with the right, but not obligation, to purchase the licensed IP asset outright from the licensor for a specified strike price within a specified time period. The put option would provide the IP owner/licensor with the right, but not obligation, to sell the licensed IP asset outright to the licensee for a specified strike price within a specified time period.

Similar to call and put options in the financial marketplace, the options in accordance with the methods presented herein may have an expiration date, and must be exercised prior to their expiration, for the option's holder to force transfer of ownership of the IP asset exercised. This expiration date may be earlier than expiration of the asset itself or may be set so that the option expires with expiration of the asset. For example, if the option is for ownership transfer of a patent that shall expire in 20 years (the patent's term), then the expiration date of the option may be set so that the option exists for 10 years of the patent's term prior to option expiration. Alternatively, the option may exist for the entire term of the patent, and expire only upon expiration of the patent. In the instance in which the IP asset has an indefinite term, such as with trade secrets or trademarks that are maintained in force, or where the IP asset has a longer-than-lifetime term, such as with copyrights, the call or put options may be “evergreen”, i.e., structured without a definite expiration date. Such “evergreen” options may be perpetual, lasting for an indefinite time period (e.g., until the parties make a future agreement that the option shall expire), and may be exercised at anytime.

For options with definite expiration dates, the specified time period over which an option may be exercised may vary. For example, analogous to the structure of European-style call/put financial options, the option may only be exercised during a short time just prior its expiration. In another embodiment, analogous to the structure of American-style call/put financial options, the option may be exercised any time during the life of the option. In one embodiment, the license agreement may include a provision that allows the the expiration date to be changed so as to extend the life of the option. For example, the extension of option life may be available upon payment of sum of money, or by virtue of the licensee meeting or not meeting specified milestones in the licensed IP commercialization effort.

In the methods of FIGS. 1 and 2, at steps 14 and 24, respectively, an unexpired call or put option included in the license agreement may be exercised. If the call or put option is an “evergreen” option, as described above, the option is necessarily unexpired since the option has no definite expiration date. If the option is exercised, then in the method of FIG. 1, the IP owner/licensor may receive payment of the strike price (step 16) and transfers ownership of the IP asset to the licensee (step 18). Correspondingly, in the method of FIG. 2, the licensee pays the strike price (step 26) in return for ownership of the IP asset (step 28). If the option exercised was a put option held by the IP owner/licensor, then the transfer of ownership (steps 18 and 28) is a forced sale to the licensee of the IP asset. If the option exercised was a call option held by the licensee, then the transfer of ownership is a forced purchase from the licensee. As with the license payments, the strike price can be in terms of one or more forms of consideration. For example, the strike price payment to the IP owner/licensor may be a license right in or an assignment of an IP asset owned by the licensee. Furthermore, in one embodiment, the strike price may adjusted in accordance with a given metric. For example, the strike price may be adjusted based on a measure of inflation of a particular currency or based on the extent of sales (e.g., volume and/or profit) of licensed product, or the strike price may simply increase or decrease, by a variable or constant magnitude over time.

If the option is not exercised, then the license fees set forth in the license agreement remain operative. For example, if the agreement's payment terms included on-going royalties, then the licensee must continue to make payments for the licensed IP right in accordance with these terms. If the agreement's payment terms included only a previously paid lump-sum payment, then the licensee has no further payments; however, the term of the license may expire, and unless the license is renewed, the licensee may be in a position of infringement of the IP asset. Thus, a call option provision on a running-royalty license agreement would provide the licensee a means of relieving itself from burdensome, future running royalty payments in the event of a successful IP commercialization. Resource constrained licensees could use a call option provision to forego costly upfront payments and to provide more latitude for payment of higher running royalty rates. A put option would provide the licensor a means of monetizing uncertain future running royalty payments by instead receiving payment of the strike price. A put option may also be attractive from the perspective of a licensee in that it would be expected to place downward pressure on negotiated up-front and/or running royalty rates.

For a running-royalty patent license agreement, for example, a call option provision may also be attractive from the perspective of the patent licensor in that it would allow for participation in the future upside of the patented technology commercialization effort and discourage licensee design-around efforts. Further, since it would be in the licensee interest to increase the value of the call option, the licensee would be encouraged to make investments in the subject technology. Similarly, a put option would simultaneously encourage licensee investment in the subject technology (to make the put option less valuable) and discourage licensee design-around efforts. A put option provision on the running-royalty patent license agreement provides the licensor a means of monetizing on the patent independent of the success of the technology commercialization by the licensee.

The licensed IP right may be any subset of the body of rights associated with having an IP asset. For example, in one embodiment, the IP asset is a patent, and the IP right may be one or more of the rights to manufacture (or have manufactured), import, use, offer to sell, or sell (or have sold) a product incorporating technology covered by the patent. Further, the licensed IP right may be a plurality of IP rights associated with a plurality of IP assets, such as licensed rights on a bundle of patents related to a particular technology. The plurality of licensed rights may also be a combination of rights under different types of IP assets, such as a combination of rights under both patents and trademarks.

In addition to IP license agreements which overtly provide a license grant in IP assets, the methods of FIGS. 1 and 2 extend to other IP transactions which give a receiving party rights in IP. Therefore, as used herein, “license agreement” and “licensing”, and “licensee” refer not only to such overt IP licenses and the party receiving the benefit of the IP license, respectively, but also refer to other IP transactions and their beneficiaries. For example, deferred asset purchase agreements, freedom-to-operate agreements, covenant-not-to-sue agreements, or any other agreements that provide a beneficiary rights in IP are IP licenses, which in accordance with the present invention may include derivative provisions to allow for future assignment of IP rights or transfer of ownership in the underlying IP asset.

### HYPOTHETICAL EXAMPLES

Specific examples are presented below for exemplary purposes only. The examples are presented only to further enable one of skill in the art to perform the described methods. The presented examples should not be interpreted to limit the scope of the present invention in any manner.

### Example 1

Assume a patent license agreement with a 10% running royalty on sales of products incorporating the subject technology and a 10 year call option with a strike price of $5 million. Under such a scenario, the licensee would pay a 10% royalty on sales but would have the option to purchase the patent outright for $5 million at any time over the next 10 years. The financial payoffs of structuring an agreement in such a way are similar to those achieved by the inclusion of a maximum royalty provision, in that the licensee may exercise the call option and pay $5 million to then be absolved from any further royalty obligations. However, unlike a license with a maximum royalty provision, the execution of a call option would convey the right of patent ownership to the licensee. As a result, the use of a call option would likely provide a greater incentive to the licensee to invest in and commercialize the technology in that the agreement would provide, at the option of the licensee, all of the benefits associated with ownership of the patent including, but not limited to, the ability to enter license agreements and collect royalties from third parties. Furthermore, because the option price is set at a predetermined level which is not influenced by the extent to which the technology is commercialized, investments made by the licensee would serve to significantly increase the value of its call option. From the licensor's perspective, although such a license structure does not guarantee a minimum payoff, as a result of the control conferred to the licensee and the duration of the option, the negotiated strike price would likely be set at a rate in excess of any guaranteed minimum royalty payments that the licensor might be able to negotiate. Moreover, any additional investment made by the licensee into the subject technology may render the $5 million payment ceiling a bargain to licensee.

### Example 2

Assume a patent license agreement with a 5% running royalty on sales of products incorporating the subject technology and a 10 year put option with a strike price of $5 million. The financial payoffs of structuring an agreement in such a way are similar to those achieved by the inclusion of a guaranteed minimum royalty provision, in that the licensor may receive at least $5 million under the agreement should the licensor choose to exercise the put option. However, unlike a guaranteed minimum royalty provision, the use of a put option allows for the patent holder to “wash his hands” of the technology by forcing a sale to the licensee. In such an event the licensor would no longer be responsible for the management of the portfolio, payment of maintenance fees, or any other activity required maintain the technology for the purpose of complying with the terms of the license agreement. Furthermore, because structuring the agreement in such a way would both guarantee the licensor a minimum payment and provide an opportunity to benefit from the upside in the event that the commercialization of the technology exceeds the parties expectations, it would be expected that the licensee would have significant leverage to negotiate a lower royalty rate.

### Example 3

A license agreement is structured by identifying an IP asset, a license fee for an IP right corresponding to the IP asset (e.g., a patent), a strike price at which ownership of the IP asset may be transferred and an expiration date prior to which ownership may be transferred (i.e., either purchased or sold) at the strike price. A call option and/or a put option with the identified strike price and expiration date are included in the license agreement, and the license agreement is then offered for execution. The call option provision provides a licensee a right to purchase ownership of the IP asset at the strike price within a specified time period prior to the expiration date. The put option provision provides an IP owner/licensor a right to sell ownership of the IP asset at the strike price within a specified time period prior to the expiration date.

Additional IP assets may be identified, and license fees for rights under the additional IP assets, along with call or put options for purchase or sale of these additional IP assets, may be included in the license agreement. For example, the license agreement offered for execution may include a license to a patent with a call option held by the licensee for optional purchase of the patent, along with a license to a second patent with second call option for optional purchase of the second patent. Further, a single call or put option can be associated with a transfer of a plurality of IP assets, as a bundle. For example, a call option be associated with transfer of multiple patents, or may be associated with transfer of a patent and any future patents issuing from continuing applications.

The license agreement may further be structured to include cross-licensing and call/put options to permit cross-selling of IP. For instance, a first party receives a license under a first IP asset with a call option to purchase the asset from a second party, and the second party receives a license under a second IP asset with a call option to purchase the asset from the first party.

### Example 4

An agreement is structured to provide for transfer of an IP right in the IP asset from a first party to a second party in exchange for payment, which may be any form of consideration. A term of the agreement may include a call option providing the first party the right to buy back the IP right, and/or a put option providing the second party the right to sell back the IP right.

The IP right bought/sold by exercise of the call or put option may be license rights in the IP asset. Thus, the agreement is structured to include call/put options that return the rights granted in the IP back to the IP owner/licensor. For example, call options could be also written by the licensee such that the licensor could “call back” rights granted in IP. This might be beneficial for parties like pharmaceutical companies who want to be able to “call back” IP rights in the event of a blockbuster discovery. Another example is that the licensor of a copyrighted character or trademark might want to “call back” the IP rights if they is used in a way that the licensor doesn't approve, such as if a licensee of a popular comic character for children made handguns endorsed by that comic character. The inclusion of such “call back” provisions might encourage more risk taking on the part of the licensor because they would be able to recover and repair the IP in the event of a disagreement with the licensee. The opposite is true with respect to put options. If a licensee felt too constrained by choices or demands of a licensor, he could “put back” the IP rights. For example, a non-exclusive licensee of the comic character who wanted to make lunch boxes endorsed by that comic character could “put back” the IP rights and recover some of its investment in the event that the owner of the IP also was commercializing handguns endorsed by that comic character (thereby impairing the market for licensee's lunchboxes).

### Conclusion

While various embodiments of the presented method have been described, it should be understood that they have been presented by way of example, and not limitation. It will be apparent to a person skilled in the relevant art that various alternatives may be incorporated within the presented method without departing from the spirit and scope of the invention. For example, a patent being licensed may be encumbered such that the owner does not have the right to transfer full ownership title and assignment of the patent. In this case, the license may include a put option (or call option) to sell (or buy) a fully-paid up worldwide exclusive or nonexclusive license at a specified price.

Thus the present invention should not be limited by any of the above-described exemplary embodiments. Further, the Abstract and Summary of the Invention Sections are not intended to be limiting as to the scope of the present invention in any way. The breadth and scope of the present invention should be defined only in accordance with the following claims and their equivalents.

What is claimed is:

1. A method of transacting intellectual property (IP) comprising:
licensing an IP right corresponding to an IP asset to a licensee, according to an agreement;
receiving payment from the licensee for the IP right according to terms of the agreement,
wherein a term of the agreement includes an option, wherein the option provides one of (i) a right to the licensee to purchase ownership of the IP asset at a predetermined strike price and (ii) a right to an IP owner to sell ownership of the IP asset at a predetermined strike price,
whereby if the option is exercised, the IP owner receives payment from the licensee of the strike price and ownership of the IP asset is transferred to the licensee.

2. The method of claim 1, wherein the IP asset is a patent, and wherein the IP right is at least one of the rights to (i) manufacture, (ii) use, (iii) import, (iv) offer to sell, and (v) sell a product having technology covered by the patent.

3. The method of claim 1, wherein the IP asset is a plurality of IP assets, wherein one of the plurality of IP assets is a patent and another of the plurality of IP assets is a trademark, and wherein the IP right is a plurality of IP rights corresponding to the plurality of IP assets.

4. The method of claim 1, wherein payment from the licensee for the IP right includes a lump-sum payment that is due upon execution of the agreement.

5. The method of claim 1, wherein payment from the licensee for the IP right includes a running-royalty of periodic payments.

6. The method of claim 1, wherein the agreement includes a term for adjusting the strike price in accordance with a given metric.

7. The method of claim 6, wherein the given metric is a measure of inflation of a particular currency such that the strike price is inflation-adjusted.

8. The method of claim 1, wherein the agreement includes a term that provides a specified time period for the option to be exercised, wherein the option expires if the option is not exercised within the specified time period.

9. The method of claim 1, wherein payment from the licensee for the IP right includes a license to the IP owner by the licensee of an IP right corresponding to a second IP asset owned by the licensee.

10. A method of transacting intellectual property comprising:
obtaining, by a licensee, a license of an IP right corresponding to an IP asset according to an agreement;
making payment for the IP right according to terms of the agreement,
wherein a term of the agreement includes an option, wherein the option provides one of (i) a right to the licensee to purchase ownership of the IP asset at a predetermined strike price and (ii) a right to an IP owner to sell ownership of the IP asset at a predetermined strike price,
whereby if the option is exercised, the licensee makes a payment to the IP owner of the strike price and the licensee obtains ownership of the IP asset.

11. The method of claim 10, wherein the agreement includes a term that provides a specified time period for the option to be exercised, wherein the option expires if the option is not exercised within the specified time period.

12. The method of claim 10, wherein the IP asset is a patent, and wherein the IP right is at least one of the rights to (i) manufacture, (ii) use, (iii) import, (iv) offer to sell, and (v) sell a product having technology covered by the patent.

13. The method of claim 10, wherein payment from the licensee for the IP right includes a lump-sum payment that is due upon execution of the agreement.

14. The method of claim 10, wherein the IP asset is a plurality of IP assets, wherein one of the plurality of IP assets is a patent and another of the plurality of IP assets is a trademark, and wherein the licensed IP right is a plurality of IP rights corresponding to the plurality of IP assets.

15. A method of transacting intellectual property, comprising:
identifying an IP asset;
identifying a fee for an IP right corresponding to the IP asset;
identifying a strike price at which ownership of the IP asset may be transferred; and
offering for execution an agreement which grants the IP right to a receiving party in exchange for payment of the fee to an IP owner, wherein a term of the agreement includes at least one of (i) a call option providing the receiving party a right to purchase ownership of the IP asset at the strike price and (ii) a put option providing the IP owner a right to sell ownership of the IP asset at the strike price.

16. The method of claim 15, wherein the IP asset is a patent, and wherein the IP right is at least one of the rights to (i) manufacture, (ii) use, (iii) import, (iv) offer to sell, and (v) sell a product having technology covered by the patent.

17. The method of claim 15, wherein the IP asset is a plurality of IP assets, wherein one of the plurality of IP assets is a patent and another of the plurality of IP assets is a trademark, and wherein the IP right is a plurality of IP rights corresponding to the plurality of IP assets.

18. The method of claim 15, wherein the fee for the IP right includes a running-royalty of periodic payments.

19. The method of claim 15, wherein the fee includes a license to the IP owner by the receiving party of an IP right corresponding to a second IP asset owned by the receiving party.

20. The method of claim 15, wherein the license agreement includes the put option.

21. The method of claim 15, wherein the license agreement includes the call option.

22. The method of claim 15, further comprising identifying an expiration date, wherein ownership of the IP asset may be transferred at the strike price prior to the expiration date.

23. The method of claim 22, wherein the agreement includes the put option, wherein the put option provides the IP owner the right to sell ownership of the IP asset at the strike price within a specified time period prior to the expiration date.

24. The method of claim 22, wherein the license agreement includes the call option, wherein the call option provides the receiving party the right to purchase ownership of the IP asset at the strike price within a specified time period prior to the expiration date.

25. The method of claim 15, further comprising,
identifying a second IP asset;
identifying a second strike price at which ownership of the second IP asset may be transferred; and
wherein a term of the agreement includes at least one of (i) a call option providing the receiving a right to purchase ownership of the second IP asset at the second strike price and (ii) a put option providing the IP owner a right to sell ownership of the second IP asset.

26. The method of claim 25, wherein one of the first and second IP assets is a patent, and wherein the other IP asset is a trademark.

27. The method of claim 15, further comprising,
identifying a second IP asset, wherein the second IP asset is owned by the receiving party;
identifying a second strike price at which ownership of the second IP asset may be transferred; and
wherein a term of the agreement includes at least one of (i) a call option providing the IP owner of the first IP asset a right to purchase ownership of the second IP asset at the second strike price and (ii) a put option providing the receiving party a right to sell ownership of the second IP asset at the second strike price.

28. The method of claim 27 wherein the first and second IP assets are patents.

29. The method of claim 27, further comprising identifying an expiration date, wherein ownership of the second IP asset may be transferred at the second strike price prior to the expiration date.

30. A method of transacting intellectual property (IP) comprising:
transferring, by an IP owner, an IP right corresponding to an IP asset to a receiving party, according to an agreement;
wherein a term of the agreement includes an option providing one of (i) a right to the IP owner to purchase back the IP right at a strike price and (ii) a right to the receiving party to sell the IP right back to the IP owner at a strike price,
whereby if the option is exercised, the receiving party receives payment from the IP owner of the strike price and the IP right is transferred to the IP owner.

31. The method of claim 30, further comprising receiving payment from the receiving party for the transferred IP right according to terms of the agreement.

32. The method of claim 30, wherein the agreement includes a term that provides a specified time period for the option to be exercised, wherein the option expires if the option is not exercised within the specified time period.
